(19) United States
(12) Patent Application Publication
(10) Pub. No.: US 2009/0088075 A1
(43) Pub. Date: Apr. 2, 2009

(54) Method and System for Enhance Roaming and Connectivity in MIMO-Based Systems

(76) Inventor: Mark P. Orlassino, Centereach, NY (US)

Correspondence Address: Fay Kaplun & Marcin, LLP/ Motorola, 150 Broadway Suite 702, New York, NY, 10038, US

(21) Appl. No.: 11/863,850

(22) Filed: Sep. 28, 2007

(51) Int. Cl. H04B 7/00

(52) U.S. Cl. 455/41.2

(57) ABSTRACT

A system and method for communicating with a first network device via a first communication link established by a plurality of transceivers, the first communication link including a plurality of wireless signals and communicating with a second network device via a second communication link established by at least one of the plurality of transceivers, the second communication link including at least one wireless signals, wherein the at least one of the plurality of the receivers terminates one of the plurality of wireless signals communicating with the first network device and at least one other one of the plurality of transceivers maintains an other one of the plurality of signals communicating with the first network device.

### FIELD OF INVENTION

The present invention relates to systems and methods used for communicating between wireless mobile computing devices within a wireless communications network. Specifically, the exemplary embodiments related to systems and methods for simultaneous communication between multiple MIMO devices, wherein each of the MIMO devices has multiple transceivers.

### BACKGROUND

Wireless networking has emerged as an inexpensive technology for connecting multiple users with other users within a wireless coverage area of a network as well as providing connections to other external networks, such as the World Wide Web. An exemplary wireless network may be a wireless local area network (“WLAN”) for providing radio communication between several devices using at least one wireless protocol. A wireless local area network may use radio frequency (“RF”) communication channels to communicate between multiple mobile units (“MUs”) and multiple stationary access points. The access points or access ports (both may be referred to herein as “APs”) of the WLAN may be positioned in various locations of the environment to prevent any coverage gaps in the wireless coverage.

A WLAN is a flexible data communications system that may either replace or extend a conventional, wired network. The WLAN may provide added functionality and mobility over a distributed environment. That is, the wired LAN transmits data from a first computing device to a further computing device across cables or wires that provide a link to the network and any devices connected thereto. The WLAN, however, relies upon radio waves to transfer data between wireless devices. Data is superimposed onto the radio wave through a process called modulation, whereby a carrier wave acts as a transmission medium.

Exchange of data between the wireless devices over the WLAN has been defined and regulated by standards ratified by the Institute of Electrical and Electronics Engineering (IEEE). These standards include a communication protocol generally known as 802.11, and having several versions, including 802.11a, 802.11b (“Wi-Fi”), 802.11e, 802.11g, 802.11n, and 802.11r. Recently, there has been a surge in deployment of 802.11-based wireless infrastructure networks to provide WLAN data sharing and wireless Internet access services in public places (e.g., “hot spots”).

In any wireless communications network, the term roaming may be used to describe the extension of service to an MU in motion from one AP to another AP. When a wireless user roams within a covered region during a call session, a network switch may transfer, or handoff, the MU between APs. A handoff may occur if the MU moves out of range of a current AP and can receive a stronger signal from a neighboring AP. In addition, a handoff may occur if the current AP has reached a servicing capacity and the neighboring AP is available for service. However, as an MU is handed-off from one AP to the next, portions of the “digitized” voice data may be lost during the transition.

### SUMMARY OF THE INVENTION

A method for communicating with a first network device via a first communication link established by a plurality of transceivers, the first communication link including a plurality of wireless signals and communicating with a second network device via a second communication link established by at least one of the plurality of transceivers, the second communication link including at least one wireless signals, wherein the at least one of the plurality of the receivers terminates one of the plurality of wireless signals communicating with the first network device and at least one other one of the plurality of transceivers maintains an other one of the plurality of signals communicating with the first network device.

A system having a first computing device including a first plurality of transceivers which transmit multiple wireless signals and receive multiple wireless signals, a second computing device including a second plurality of transceivers, wherein, when the first computing device is roaming from the second computing device, the second computing device transmits and receives data over a first communication link between only a portion of the second plurality of transceivers and a corresponding first portion of the first plurality of transceivers and a third computing device including a third plurality of transceivers, wherein, when the first computing device is roaming to the third computing device, the third computing device transmits and receives data over a second communication link between only a portion of the third plurality of transceivers and a corresponding second portion of the first plurality of transceivers, wherein the transceivers of the second portion of the first plurality of transceivers are different from the transceivers of the first portion of the first plurality of transceivers.

A computing device having a plurality of transceivers transmitting and receiving data over wireless signals, the plurality of transceivers transmitting multiple wireless signals and receiving multiple wireless signals, a first portion of the plurality of transceivers in communication with a first wireless device within a wireless local area network, a second portion of the plurality of transceivers in communication with a second wireless device within the wireless local area network and a processor to reconstruct multiple wireless signals received from at least one of the first wireless device and the second wireless device.

### BRIEF DESCRIPTION OF THE DRAWINGS

FIG. 1 shows a wireless communication system utilizing wireless communication devices having multiple transceivers.

FIG. 2 shows a wireless communication system utilizing multiple wireless communication devices to roam according to the present invention.

FIG. 3 shows an exemplary method for MIMO roaming for wireless communications according to the present invention.

FIG. 4 shows an alternative system according to embodiments of the present invention, wherein a plurality of exemplary MUs operate within a mesh network infrastructure.

FIGS. 5a-5c show a further alternative system according to embodiments of the present invention, wherein an exemplary MU and a plurality of APs operate within a WLAN.

### DETAILED DESCRIPTION

The present invention may be further understood with reference to the following description of exemplary embodiments and the related appended drawings, wherein like elements are provided with the same reference numerals. The exemplary embodiments of the present invention are related to systems and methods used for communicating between wireless mobile units (“MUs”) and access points (“APs”) within a wireless communications network. Specifically, the exemplary embodiments related to systems and methods for simultaneous communication between at least one MU and multiple APs, wherein the MU and each of the APs have multiple transceivers. Thus, the present invention may provide seamless communication while the MU roams between the multiple APs. Furthermore, the present invention allows for an improved Quality of Service (“QoS”) scheme for wireless communications while maintaining a high level of security. Those skilled in the art will understand that the term “AP” according to the present invention may also be used to describe access ports or any other device that is capable of receiving and transmitting wireless signals within a network architecture in accordance with the principles and functionality described herein. Thus, the use of a wireless Access Point is only exemplary.

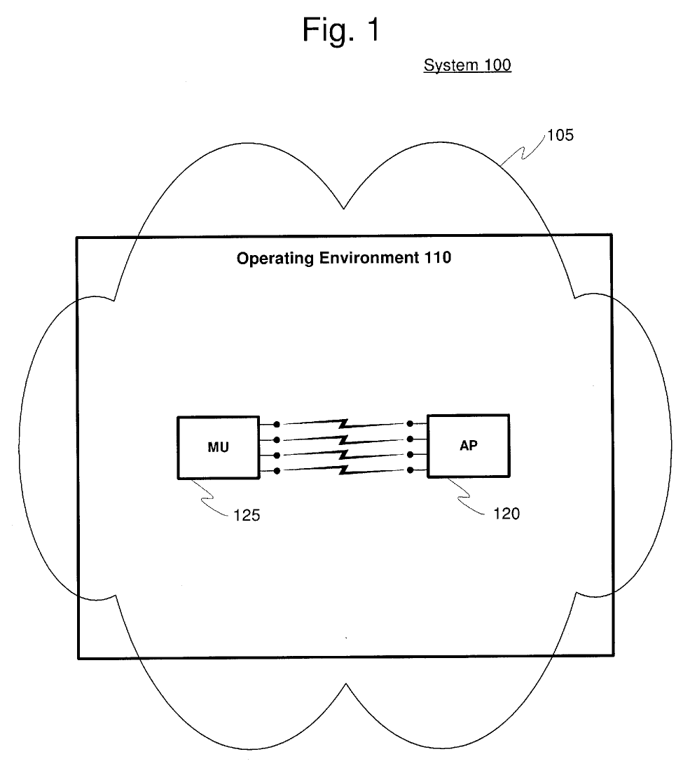

FIG. 1 shows a wireless communication system 100 utilizing wireless communication devices having multiple transceivers. The system 100 may include a network, such as a wireless local area network (“WLAN”) 105 deployed within an operating environment 110. As understood by those skilled in the art, the operating environment 110 may be, for example, an enclosed environment (e.g., a warehouse, office, home, department store, etc.) or an open-air environment (e.g., park, campus, etc.) or a combination thereof. The WLAN 105 may include wireless communication devices, such as, an AP 120, and one or more mobile computing devices, such as an MU 125, wirelessly communicating therewith. The AP 120 may be connected to a server or other network device (not shown) via the WLAN 105. While the exemplary network may be described has being a wireless network infrastructure, the present invention may also be implemented into a wired infrastructure having a wireless AP. Furthermore, it should be noted that aside from a WLAN, the exemplary embodiments of the present invention may be implemented within any wireless network architecture, such as, for example, as a mesh network (e.g., an ad-hoc network), a wireless personal area network (“WPAN”) (e.g., Bluetooth, ZigBee), etc.

Radio frequency (“RF”) signals including data packets may be transmitted between the MU 125 and the AP 120 over a radio channel. As understood by those skilled in the art, the data packets may be transmitted using a modulated RF signal having a common frequency (e.g., 2.4 GHz, 5 GHz). Furthermore, the data packets may include conventional 802.11 packets, such as, authentication, control and data packets. The data packets travel between the AP 120 and the MU 125 along a plurality of paths within the operating environment 110. While the exemplary embodiments are described with reference to communication using the 802.11x standard, those skilled in the art will understand that the present invention may be implemented on any wireless network regardless of the communication protocol.

The MU 125 may include multiple transceivers for transmitting wireless signals simultaneously to the AP 120. For example, the MU 125 may include four transmitters. In addition, the AP 120 may also include multiple receivers for receiving the transmitted signals from the MU 125. For example, the AP 120 may include four receivers, wherein the receivers are capable of creating a communication link between the AP 120 and the MU 125. Upon receiving the signals, the AP 120 uses signal processing techniques in order to reconstruct the wireless signals. Furthermore, the MU 125 includes four receivers and the AP 120 includes four transmitters to allow for a bi-directional communication link between the MU 125 and the AP 120. While the MU 125 and the AP 120 are illustrated in FIG. 1 as each having four transceivers, those skilled in the art would understand that the MU 125 and the AP 120 may include any multiple number of transceivers.

The exemplary MU 125 may use four transmitters and four receivers simultaneously to increase the data transfer rate over the communication link to the AP 120. However, the MU 125 only uses each of the transmitters to transmit signals to a single device, namely the AP 120. Since the MU 125 simultaneously transmits on all of the transmitters to the receivers of the AP 120, there may be a significant reduction of the quality of the wireless connection while the MU 125 roams. Specifically, while the MU 125 roams away from the AP 120, the MU 125 will cease transmitting to the AP 120 on the four transmitters and initiate communication with a neighboring AP using the four transmitters. The switch from one AP to another AP by the MU may be described as a handoff or a roam. A handoff may occur if the MU 125 moves beyond the range of a current AP 120 and can receive a stronger signal from a neighboring AP. In addition, a handoff may occur if the current AP 120 has reached a servicing capacity and the neighboring AP is within range and available for service.

However, as the MU 125 is handed-off between APs, portions of the data may be lost during the transition. When the MU 125 is conducting applications that demand high data-transfer rates, such as, for example, wireless Voice over Internet Protocol (“VoIP”) communications, the handoff during a roam may significantly affect the quality of the application. Specifically, data transmitted from either the MU 125 or AP 120 may fail to reach the destination or may be delayed during a roam. The failure of any data to reach the destination may result in transmission interruptions such as voice dropout, distorted audio (e.g., echoing, transmission hiccups), loss of connectivity, or simply degradation of voice quality. While the exemplary embodiments are described with reference to voice communications, the present invention may be implemented to improve communication of any type, such as, for example, the communications of data packets, control packets, management packets, real-time packets, streaming multimedia packets, etc.

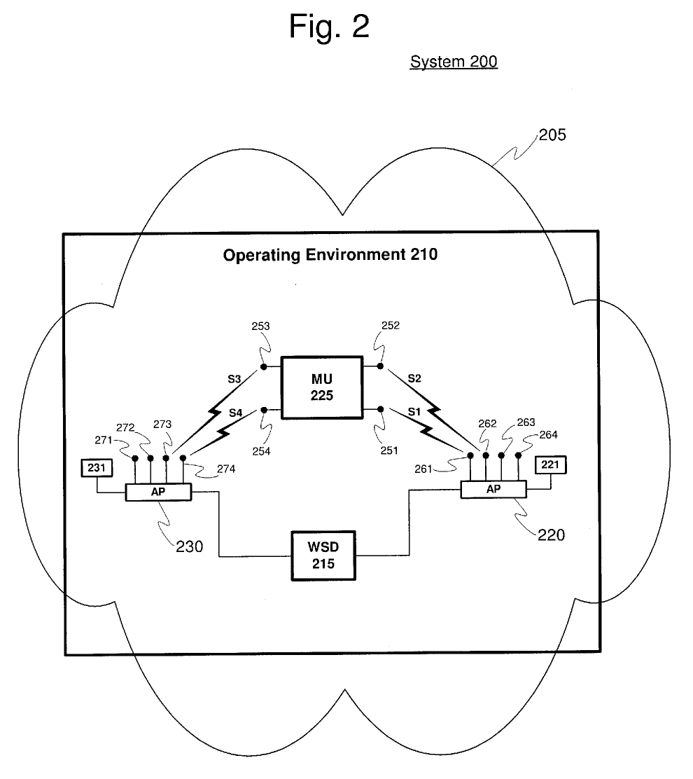

FIG. 2 shows a wireless communication system 200 utilizing multiple wireless communication devices to roam according to the present invention. As described above, the communication system 200 may be implemented within a wireless network architecture or within a wired network architecture utilizing a wireless AP. Similar to system 100, the system 200 may be a WLAN 205 deployed within an operating environment 210 to provide continuous wireless coverage throughout an operating environment 210. The WLAN 205 may include a wireless switching device (“WSD”) 215 as well as multiple wireless communication devices, such as, an AP 220 and an AP 230, wherein each communication device has a respective coverage area. Furthermore, the WLAN 205 may also include one or more mobile computing devices, such as a MU 225, wirelessly communicating therewith. Both the AP 220 and the AP 230 may be connected to a server, or other network device, via the WSD 215. Those skilled in the art will understand that the communication system 200 is only exemplary and that the present invention may be applied to any type of wireless network topology. In addition, those skilled in the art will understand that the present invention does not need to be implemented on a network including a wireless switch. That is, the present invention may be implemented on any network that is capable of handling VoIP or other “packetized” voice transmissions in accordance with the principles and functionality described herein. Thus, the use of a wireless switch based network is only exemplary. According to the alternative embodiments, the exemplary system 200 may be implemented within a wireless ad-hoc or mesh network infrastructure.

The WSD 215 may be a robust hardware component that controls the connections of the APs 220, 230 of the wireless communication system 200. The WSD 215 may be responsible for the management of traffic and AP handoffs, as well as the security of the data transferred over the WLAN 205. In other words, the WSD 215 may monitor the status of the APs 220, 230 in order to detect a failure of an AP or when an AP has reached maximum capacity. Upon such detection, the WSD 215 may route the data traffic via another AP. In addition, the WSD 215 may be connected to the APs 220, 230 via a wired or wireless connection. Again, as described above in other network topologies, these functions may be carried out by other devices.

According to exemplary embodiments of the present invention, the WLAN 205 may be configured as a multiple-in-multiple-out (“MIMO”) shared WLAN architecture. Though, FIG. 2 only shows a single MU 225 within the WLAN 205, those skilled in the art would understand that the WLAN 205 may include any number and type of mobile computing devices, such as, for example, personal digital assistants (“PDAs”), cell phones, VoIP-based wireless/wired phones, laptops, handheld computers, portable barcode scanners, etc.). Those skilled in the art would further understand that the MU 225 may include a non-mobile computing device attached to a wireless device (e.g., a desktop computer with a network interface card).

Those skilled in the art would understand that a conventional WLAN may utilize a single-in-single-out (“SISO”) cellular sharing architecture, wherein the data is transferred over a single radio channel in a cell. However, since the channel is shared by all wireless devices (e.g., MU 225 and APs 220, 230) within the cell, each of the devices must contend for access to the channel, thus, allowing only one device to transmit on the radio channel at a given time. Consequently, the conventional WLAN presents a number of limitations (e.g., delayed transmission times, failed transmission, increased network overhead, limited scalability, etc.).

In order to overcome the limitations of the conventional WLAN, the WLAN 205 according to the present invention is developed as a MIMO shared WLAN architecture. A MIMO mode may use spatial multiplexing to increase a bit rate and accuracy of data sent between the wireless devices. In the MIMO mode, a single high-speed data stream (e.g., 200 Mbps) may be divided into several low-speed data streams (e.g., 50 Mbps), transmitted to the wireless device (e.g., MU 225) and recombined into the high-speed data stream for resolving the transmission. Therefore, the exemplary MU 225 may simultaneously transfer data over multiple transceivers to a single device (e.g., AP 220) having multiple transceivers in order to dramatically increase the data transfer rate. While the MU 225 may use all of the multiple transceivers to transmit to the single device, the exemplary embodiments of the present invention provide that the MU 225 may use the multiple transceivers to simultaneously communicate with multiple devices (e.g., AP 220 and AP 230) in order to improve the operations of the MU 225. These improvement in the operations of the MU 225 may include, but are not limited to, improved quality of service during voice applications, improved handoffs between APs during a roam, improved transmission of data packets from the APs 220, 230 to the MU 225, etc.

According to the present invention, the APs 220, 230 and the MU 225 may utilize a first mode of communication (e.g., 802.11a, 802.11b, 802.11g) and a second mode of communication (e.g., MIMO, 802.11n, 802.11r). In order to utilize the MIMO mode, each of the APs 220, 230 may have an architecture including a processor 221, 231 and two or more transceivers 261-264, 271-274. Accordingly, each transceiver 261-264, 271-274, is capable of transmitting and receiving one or more independent signals concurrently and at a substantially common frequency (e.g., the radio channel). Each of the processors 221, 231 of the APs 220, 230 may resolve the wireless communication of the signals received from the MU 225 or from any further APs.

In addition, the MU 225 may utilize the MIMO mode using an architecture including a processor 226, and two or more transceivers 251-254. The transceivers 251-254 allow the MU 225 to receive or transmit one or more independent signals concurrently and at a substantially common frequency to and from the APs 220, 230. The processor 226 of the MU 125 may resolve the wireless communication of the received signals from the APs 220, 230 or from any further MUs.

Upon receiving the signals, the APs 220, 230 may use signal processing techniques in order to reconstruct the wireless signals. The signal processing techniques will be described in further detail below. Thus, the transceivers 251-254 of the MU 225 may allow for a bi-directional communication link between the MU 225 and either one of or both of the AP 220 and the AP 230. While the MU 225 and the APs 220, 230 are illustrated in FIG. 2 as each having four transceivers 251-254, 261-264 and 271-274, those skilled in the art would understand that the MU 225 and the APs 220, 230 may have any multiple number of transceivers.

The MU 225 of the exemplary embodiment of the present invention may allow the MU 225 to maintain multiple simultaneous communication links with multiple communication devices, for example, with both the AP 220 and the AP 230. Specifically, when attempting to roam from the AP 220 to the AP 230, the MU 225 may maintain communication with the AP 220 over at least one of the transceivers. While remaining in communication with the AP 220, the MU 225 may then initiate and maintain communication with at least one other device, namely AP 230, over at least one of the other transceivers. Thus, for example, the MU 225 may use the transceivers 251 and 252 to communicate with the transceivers 261 and 262 of the AP 220, and the MU 225 may also use the transceivers 253 and 254 to communicate the transceivers 273 and 274 of the AP 230. As illustrated in FIG. 2, the communication links between transceiver 251 and 252 of MU 225 and transceivers 261 and 262 of the AP 220 are represented by communication lines S1 and S2, respectively. In addition, the communication links between transceiver 253 and 254 of MU 225 and transceivers 273 and 274 of the AP 230 are represented by communication lines S3 and S4, respectively. Those skilled in the art would understand that regardless of the number of transceivers in use by the MU 225, the exemplary embodiments of the present invention allow for the MU 225 to be in simultaneous communication with multiple devices. Thus the exemplary embodiments of the present invention may eliminate data loss and latency issues as the MU 225 roams from one AP 220 to another AP 230. Latency may be defined as the delay in time between the transmission of a data packet from an origin of a communication link and the reception of that data packet at a destination of the communication link.

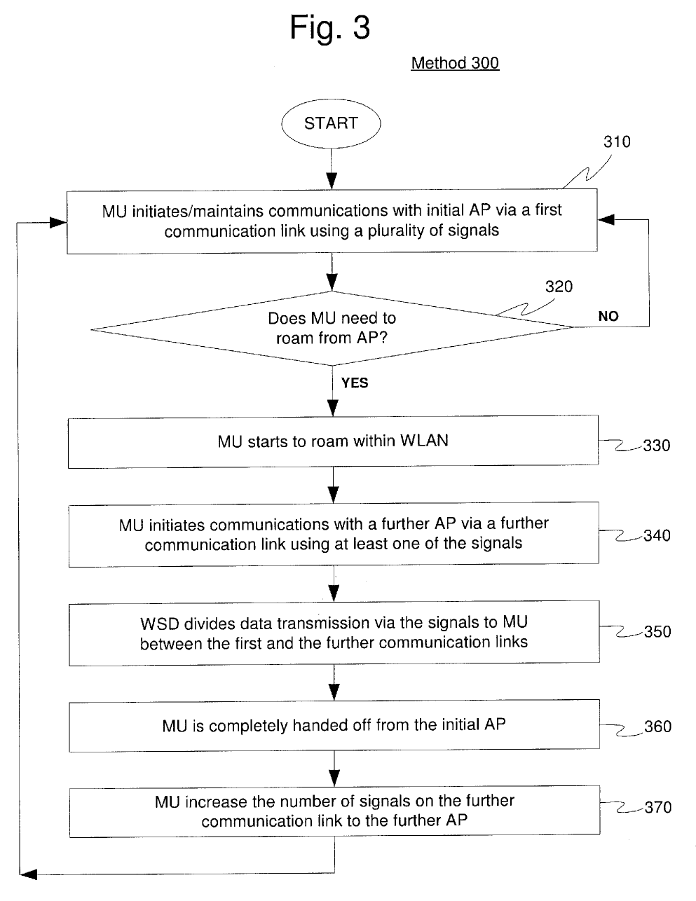

FIG. 3 shows an exemplary method 300 for MIMO roaming for wireless communications according to the present invention. The exemplary method 300 will be described with reference to the exemplary system 200 of FIG. 2. According to the present invention, the method 300 may provide seamless transitions for MIMO roaming in order to reduce the possibility of data loss during a transmission (or any other communications issues associated with roaming) while maintaining a sufficient data transfer rate as the MU 225 travels beyond the coverage of the AP 220 towards the AP 230. Furthermore, the exemplary method 300 may also provide for an improved QoS scheme for wireless communications.

In step 310, the MU 225 may initiate communication with the first AP 220 through the use of at least one of the transceivers 251-254, such as, for example, all four transceivers 251-254. The MU 225 may transmit multiple independent signals from the transceivers 251-254 to the AP 220. The number of independent signals may be directly proportional to the number of transceivers (e.g., one independent signal per transceiver). Thus, MU 225 may transmit four signals, such as, for example, S1-S4, to the AP 220.

Due to any factors contributing to signal corruption or degradation, the transceivers of the AP 220 may receive a signal that differs from the transmitted signals S1-S4. Those skilled in the art would understand that any or all of the received signals may not differ from the transmitted signals S1-S4. Accordingly, one or more the received signals may equal one or more of the transmitted signals S1-S4. In either instance, the received signals may be related to the transmitted signals S1-S4 by a signal-relation equation called a communication matrix. The communication matrix may be utilized by the processor 221 of the AP 220 to resolve multiple wireless communications received from any number of transceivers, such as 251-254, of any number of mobile computing devices, such as 225. The resolution of the communications may be performed by the processor 221 within a signal time slot over a radio channel. The AP 220 may extract the received signals using the communication matrix in order to resolve signals S1-S4. Thus, the resolution may be described a signal processing technique that reconstructs the wireless signals S1-S4 into a cohesive data transmission between MU 225 and AP 220. As would be understood by those skilled in the art, the processor 221 of the AP 220 may resolve the communication matrix using a software application.

Accordingly, the MU 225 may now transmit and receive multiple signals S1-S4 simultaneously between AP 220. The use of multiple signals may increase the over the air throughput of the wireless communication, may reduce corruption and degradation of the data packets, and may allow users of the system 200 to maintain use of devices of the 802.11x standards. Those skilled in the art would understand that throughput may be defined as the rate at which a network may send and receive data between devices. Thus, as described above, the data transfer rate between the AP 220 and the MU 225 may increase proportionate to the number of signals between the AP 220 and the MU 225. Thus, according to the exemplary method 300, the simultaneous use of signals S1-S4 may increase the transfer rate by a multiple of four.

In step 320, a determination may be made as to whether the MU 225 needs to roam from the AP 220 to a further AP, such as, for example, AP 230. The circumstances in which the MU 225 may need to roam include, but are not limited to, the strength of the signal provided by the AP 220, the level of servicing capacity of the AP 220, any interference or obstructions between the MU 225 and the AP 220, etc. Therefore, if the MU 225 needs to roam, the method 300 may continue to step 330. However, if the MU 225 does not need to roam, the method 300 may return to step 310, wherein the MU 225 may maintain communication with the AP 220.

In step 330, the MU 225 may start to roam within the WLAN 205. As the MU 225 roams away from the AP 220, the MU 225 may maintain a communication link with the AP 220 using at least one of the transceivers, such as transceivers 251 and 252, as illustrated in FIG. 2. In addition, the WSD 215 may cease communications between the MU 225 and the AP 220 over the remaining transceivers 253, 254. The cease in communications may allow the remaining transceivers 253, 254 to disassociate from the AP 220 over signals S3 and S4. However, the MU 225 may continue to transmit and receive data to and from the AP 220 via signals S1 and S2. Thus the transceivers 253 and 254 may now be available for the MU 225 to communicate with another AP. It is important to note that MU 225 may disassociate certain transceivers from the AP 220 for reasons other than roaming. For example, these reasons may include, but are not limited to, a decrease in the quality of the signals generated from the AP 220, the AP 220 has reached a maximum servicing capacity, networking equipment failure, etc.

In step 340, the MU 225 may initiate communications with a neighboring AP, such as the AP 230, through the use of at least one available transceiver, such as transceivers 253 and 254. Similar to the initiation of communications with the first AP 220, the MU 225 may transmit multiple independent signals from the remaining transceivers 253, 254 to the AP 230. As described above, the number of independent signals may be directly proportional to the number of transceivers (e.g., one independent signal per transceiver). Thus, MU 225 may transmit two signals, such as, for example, S3 and S4, to the AP 230. In MIMO mode, the MU 225 may transmit the signals S3 and S4 concurrently over the radio channel. The signals S3 and S4 may be resolved by the processor 231 of the AP 230 (and/or by a software application) in order to reconstruct the wireless signals S3 and S4 into a cohesive data transmission between MU 225 and AP 230.

In step 350, the WSD 215 may divide the data transmission to and from the MU 225 between the AP 220 and the AP 230. This division of the data transmission may be proportional to the number of transceivers that the MU 225 has in communication with each of the APs. Thus, according to the present exemplary embodiment wherein the MU 225 has two transceivers communicating with each AP, the data transmission may be divided evenly between the two APs. Although the transmission rate may be divided between the APs while the MU 225 shares at least one communication link with both the APs 220, 230, the ability for the MU 225 to simultaneously communicate with multiple APs allows for seamless handoffs between MU 225 and each of APs within the WLAN 205. As described above, the seamless handoffs of the MU 225 between the APs may be critical for any applications that demands high-data transfer rates or cannot tolerate interruption of packets requiring isochronous transport mechanisms such as, for example, voice applications and other QoS applications. Thus, the MU 225 may be partially handed off from the AP 220 to the AP 230 while the MU 225 shares a communication link with the two APs 220, 230. Advantageously, the partial handoff allows the MU 225 to initiate and maintain communication with a neighboring AP without completely breaking off communication with the first AP. Thus, the partial handoff may eliminate any potential data loss or delay during a wireless transmission to MU 225 as the MU 225 roams within the WLAN 205.

In step 360, the MU 225 may be handed off completely from the AP 220 to the AP 230. During the complete handoff, the WSD 215 may cease the data transfers between the AP 220 and the MU 225 over the transceivers 251 and 252 as the MU 225 roams beyond the coverage range of the AP 220. Accordingly, the MU 225 may now be in exclusive communication with the AP 230. Furthermore, the transceivers 251 and 252 may now be available for the MU 225 to communicate with another AP.

In step 370, the MU 225 may increase the number of signals within the communication links with the AP 230 through the use of the available transceivers 251 and 252, thereby allowing the MU 225 to communicate with the AP 230 over all of the transceivers 251-254. Specifically, MU 225 may redirect signals S and S2 to AP 230. Similar to the signal processing technique described in step 340 of the method 300, the MU 225 may transmit multiple independent signals from the currently available transceivers 251, 252 to the AP 230. Thus, MU 225 may now transmit four signals, S1-S4, to the AP 230. In MIMO mode, the MU 225 may transmit the signals S1-S4 concurrently over the radio channel. Likewise, the additional signals S1 and S2 may be resolved, in combination with the existing signals S3 and S4, by the processor 231 of the AP 230 (and/or by a software application) in order to reconstruct the wireless signals S1-S4 into a cohesive data transmission between MU 225 and AP 230.

Accordingly, the MU 225 may now transmit and receive multiple signals S1-S4 simultaneously between AP 230. As described above, the data transfer rate between the AP 230 and the MU 225 may increase proportionate to the number of signals between the AP 230 and the MU 225. Thus, according to the exemplary method 300, the simultaneous use of signals S1-S4 may increase the transfer rate by a multiple of four.

Finally, it is important to note that the method 300 may repeat the steps 310-370 as the MU 225 roams away from the AP 230 towards a further neighboring AP. This may allow the MU 225 to reinitiate further communication to another AP within the WLAN 205 as the MU 225 roams beyond the coverage area of the AP 230. Those skilled in the art would understand that the regardless of the number of APs available within the WLAN 205, the WSD 215 may direct the data transmission to the MU 225 via multiple seamless handoffs between any number of APs.

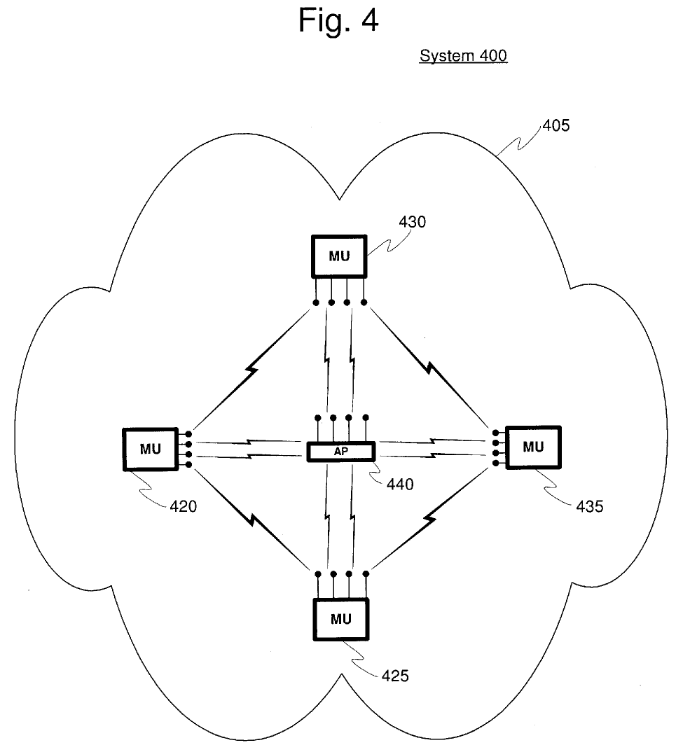

FIG. 4 shows an alternative system 400 according to embodiments of the present invention, wherein a plurality of exemplary MUs 420, 425, 430, and 435 operate within a mesh network infrastructure 405. A mesh network 405 may be described as a co-operative networking architecture that may allow for peer-to-peer communications between available computing devices within the network. The mesh network 405 may be distributed over a WLAN and route data (e.g., voice data, application data, control data, etc.) between multiple computing devices (i.e., nodes) within the network. Each of the nodes may act as repeaters to transmit data from nearby nodes to computing devices that may be too far away to reach, thereby resulting in a network that can span large distances.

The mesh network 405 may thus be extremely reliable, as each node is connected to several other nodes. If one node drops out of the network, due to hardware failure or any other reason, a neighboring node may simply find another route to the destination. In other words, the mesh network 405 may allow for continuous connections and reconfiguration around unavailable paths (e.g., busy, broken, or obstructed paths) by hopping from node to node until the destination is reached. According to one embodiment of the present invention, the mesh network 405 may be a self-configuring mobile ad-hoc network (“MANET”), wherein the MUs 420-435 may act as mobile routers connected by wireless communication links.

While the MUs 420-435 of the mesh network 405 may communicate with one another, the system 400 may further include one or more APs, such as AP 440. Similar to the MUs and the APs described in the above embodiments, each of the MUs 420-435 and the AP 440 may include a plurality of transceivers for communicating throughout the mesh network 405. Furthermore, each of the MUs 420-435 may also include a plurality of antennas corresponding to the respective plurality of transceivers such that the number of antennas for each computing device is equal to the number of transceivers. Although FIG. 4 only shows a single AP within the mesh network 405, those skilled in the art would understand that any number of APs may be utilized throughout the mesh network 405.

Each of the MUs 420-435 may include multiple transceivers for transmitting wireless signals simultaneously to one another and to the AP 440. For example, the MU 420 may include four transmitters. In addition, the AP 440 may also include multiple receivers for receiving the transmitted signals from the MUs 420-435. For example, the AP 440 may include four receivers, wherein the receivers are capable of creating a communication link between the AP 440 and each of the MUs 420-435. According to the exemplary mesh network 405 of the system 400, the MU 420 may share one or more communication links with the AP 440. While in communication with the AP 440, the MU 420 may also share one or more communication links with any number of MUs or further APs within the mesh network 405. For example, as illustrated in FIG. 4, the MU 420 may simultaneously maintain two communication links with the AP 440, one communication link with the MU 425, and a further communication link with the MU 430. Likewise, each of the other MUs 425, 430, and 435 may be in simultaneous communication with the AP 440 and any number of MUs or further APs within the mesh network 405. Furthermore, each of the MUs 420-435 may continuously reroute any of the communication links from the AP 440 to another MU, and vice versa. Thus, each of the MUs 420-435 may maintain simultaneous communication links with any combination of MUs and APs.

As each of the MUs 420-435 maintains communication with multiple computing devices (e.g., other MUs, APs, etc.) within the mesh network 405, the data transfer rate may be divided by the number of communication links used by that particular MU. For example, if MU 420 maintains four simultaneous communication links over the plurality of transceivers, the transfer rate (i.e., data throughput) may be decreased four-fold. However, these simultaneous communication links allow for the MU 420 to seamlessly transition between the plurality of computing devices. Since the wireless network of the exemplary system 400 is a mesh network 405, the MU 420 may advantageously establish further communication links with any neighboring MU while communicating with the AP 440. For example, if a further AP (not shown) within the mesh network 405 is unavailable or is operating at maximum capacity while MU 420 communicates with AP 440, then the MU 420 may simply establish an additional communication link with one of the other MUs 425-435 via an available transceiver. Thus, regardless of how the MU 420 roams within the mesh network 405, the MU 420 may remain in communication with at least one, if not multiple, computing devices of system 400 via at least one of the plurality of transceivers of the MU 420.

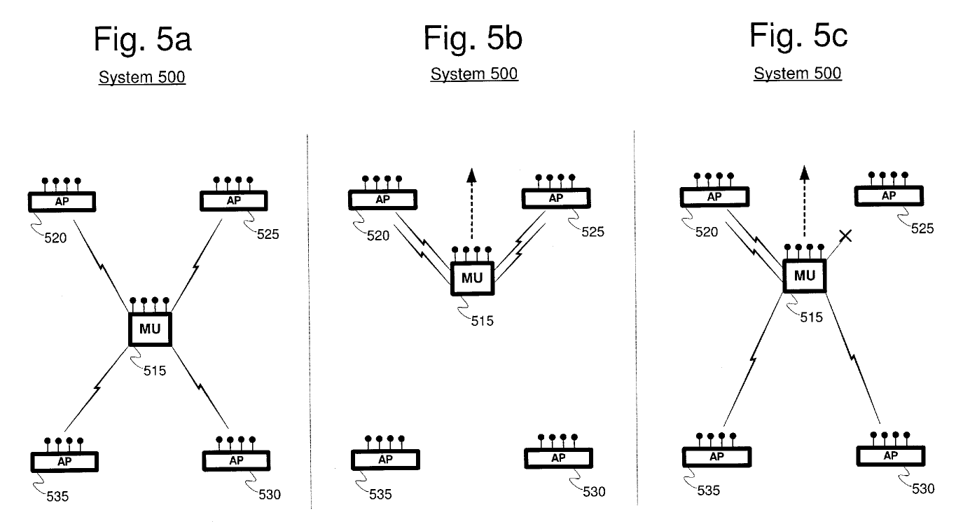

FIGS. 5a, 5b, and 5c show a further alternative system 500 according to embodiments of the present invention, wherein an exemplary MU 515 and a plurality of APs 520, 525, 530, and 535 operate within a WLAN. Each of the APs 520, 525, 530, and 535 may be positioned throughout an operating environment 510 to provide optimal wireless coverage to the MU 515. Similar to the MUs and the APs described in the above embodiments, the MUs 515 and each of the APs 520, 525, 530, and 535 may include a plurality of transceivers for communicating throughout the WLAN. Furthermore, the MU 515 and each of the APs 520, 525, 530, and 535 may also include a plurality of antennas corresponding to the respective plurality of transceivers such that the number of antennas for each computing device is equal to the number of transceivers. It should be noted that while the FIGS. 5a-5b are described in relation to the MU 515 communicating with a plurality of APs 520-535, the exemplary embodiments of the present invention may also be applied towards communications between the MU 515 and a plurality of further MUs, such as within a peer-to-peer wireless mesh network, wherein each of the further MUs include a plurality of transceivers.

The MU 515 may maintain a plurality of communication links with any number of APs 520, 525, 530, and 535 as the MU 515 roams within varying proximity to each of the APs 520, 525, 530, and 535. When the MU 515 approaches one of the APs 520, 525, 530, and 535, the MU 515 may reroute some or all of the communication links to the closest AP or APs. For example, as illustrated in FIG. 5a, the MU 515 may initially have one communication link established with each of the APs 520, 525, 530, and 535. As the MU 515 roams towards both the AP 520 and the AP 525, as illustrated in FIG. 5b, the MU 515 may reroute the communication links previously connected to the AP 530 and the AP 535 while remaining in communication with the AP 520 and the AP 525. These rerouted communication links may now be to the AP 520 and the AP 525, respectively. Thus, both the AP 520 and the AP 525 may each have two communication links with the MU 515 while the MU 515 roams in close proximity to the AP 520 and the AP 525.

Furthermore, the MU 515 may reroute any communication links away from an unavailable AP. For example, as illustrated in FIG. 5c, the AP 525 may be operating at maximum capacity. While maintaining the two communication links with the AP 520, the MU 515 may reestablish communication links with either or both of the AP 530 and the AP 535. Alternatively, the MU 515 may simply remain in exclusive communication with the AP 520. Regardless of the number of APs or the number of communication links, the MU 515 may maintain a connection to one of the computing devices within the WLAN.

While the exemplary embodiments of the present invention describe various methods and manners for providing simultaneous communications between at least one MU and multiple APs, those skilled in the art will understand that the principles and functionalities described herein may be performed in a software program, a component within a software program, a hardware component, or any combination thereof. One example would be a set of instructions stored on a computer readable storage medium (e.g. memory) executable by a processor, where the set of instructions may perform the various methods and manners according to exemplary embodiments of the present invention.

It will be apparent to those skilled in the art that various modifications may be made in the present invention, without departing from the spirit or the scope of the invention. Thus, it is intended that the present invention cover modifications and variations of this invention provided they come within the scope of the appended claimed and their equivalents.

What is claimed is:

1. A method, comprising:
communicating with a first network device via a first communication link established by a plurality of transceivers, the first communication link including a plurality of wireless signals; and
communicating with a second network device via a second communication link established by at least one of the plurality of transceivers, the second communication link including at least one wireless signals, wherein the at least one of the plurality of the receivers terminates one of the plurality of wireless signals communicating with the first network device and at least one other one of the plurality of transceivers maintains an other one of the plurality of signals communicating with the first network device.

2. The method according to claim 1, further comprising:
terminating the other one of the plurality of signals of the at least one other one of the plurality of transceivers communicating with the first network device, thereby terminating the communicating with the first network device via the first communication link.

3. The method according to claim 2, further comprising:
initiating a further signal from the at least one other one of the plurality of transceivers via the second communication link to communicate with the second network device.

4. The method according to claim 1, wherein the method is performed by a mobile unit roaming from the first network device to the second network device.

5. The method according to claim 4, wherein the method is repeated by the mobile unit roaming from the second network device to a further network device.

6. The method according to claim 1, wherein the first communication link utilizes a multiple-in-multiple-out (“MIMO”) mode.

7. The method according to claim 4, wherein the mobile unit is one of a personal digital assistant (“PDA”), a cell phone, a Voice over Internet Protocol (“VoIP”) based wireless phone, a VoIP-based wired phone, a laptop, a handheld computer, a portable barcode scanner, and a non-mobile computing device attached to a network interface card.

8. The method according to claim 1, wherein at least one of the first and second network devices is an access point.

9. A system, comprising:
a first computing device including a first plurality of transceivers which transmit multiple wireless signals and receive multiple wireless signals;
a second computing device including a second plurality of transceivers, wherein, when the first computing device is roaming from the second computing device, the second computing device transmits and receives data over a first communication link between only a portion of the second plurality of transceivers and a corresponding first portion of the first plurality of transceivers; and
a third computing device including a third plurality of transceivers, wherein, when the first computing device is roaming to the third computing device, the third computing device transmits and receives data over a second communication link between only a portion of the third plurality of transceivers and a corresponding second portion of the first plurality of transceivers, wherein the transceivers of the second portion of the first plurality of transceivers are different from the transceivers of the first portion of the first plurality of transceivers.

10. The system according to claim 9, wherein the first computing device further includes a plurality of antennas corresponding to the first plurality of transceivers such that the plurality of antennas are equal in number to the first plurality of transceivers.

11. The system according to claim 9, further including:
a wireless switching device, the wireless switching device managing the roaming of the first computing device.

12. The system according to claim 9, wherein the first communication link utilizes a multiple-in-multiple-out (“MIMO”) mode.

13. The system according to claim 9, wherein the first computing device is one of a personal digital assistant (“PDA”) a cell phone, a Voice over Internet Protocol (“VoIP”) based wireless phone, a VoIP-based wired phone, a laptop, a handheld computer, a portable barcode scanner, and a non-mobile computing device attached to a network interface card.

14. A computing device, comprising:
a plurality of transceivers transmitting and receiving data over wireless signals, the plurality of transceivers transmitting multiple wireless signals and receiving multiple wireless signals, a first portion of the plurality of transceivers in communication with a first wireless device within a wireless local area network, a second portion of the plurality of transceivers in communication with a second wireless device within the wireless local area network; and
a processor to reconstruct multiple wireless signals received from at least one of the first wireless device and the second wireless device.

15. The device according to claim 14, wherein the first wireless device is one of an access point and a mobile device.

16. The device according to claim 14, wherein the communication between the device and at least one of the first wireless device and the second wireless device utilizes a multiple-in-multiple-out (“MIMO”) mode.

17. The device according to claim 14, wherein the device is one of a security data is one of a personal digital assistant (“PDA”), a cell phone, a Voice over Internet Protocol (“VoIP”) based wireless phone, a VoIP-based wired phone, a laptop, a handheld computer, a portable barcode scanner, and a non-mobile computing device attached to a network interface card.

18. The device according to claim 14, wherein the first and second portions include all of the plurality of transceivers.

19. The device according to claim 14, wherein the communications with the first and second APs occur during a roaming of the mobile computing device.

20. The device according to claim 14, wherein the communications implement a Quality of Service (“QoS”) scheme.

21. A computing device, comprising:
a plurality of transceiving means for transmitting and receiving data over wireless signals, the plurality of transceivers transmitting multiple wireless signals and receiving multiple wireless signals, a first portion of the plurality of transceivers in communication with a first wireless device within a wireless local area network, a second portion of the plurality of transceivers in communication with a second wireless device within the wireless local area network; and
a processing means for reconstructing multiple wireless signals received from at least one of the first wireless device and the second wireless device.
